(19) United States
(12) Patent Application Publication
(10) Pub. No.: US 2004/0043807 A1
(43) Pub. Date: Mar. 4, 2004

(54) Poker game with a second chance feature

(76) Inventor: Richard M. Pennington, Reno, NV (US)

Correspondence Address: BELL, BOYD & LLOYD LLC, P. O. BOX 1135, CHICAGO, IL, 60690-1135, US

(21) Appl. No.: 10/233,245

(22) Filed: Aug. 30, 2002

(51) Int. Cl. A63F 13/00

(52) U.S. Cl. 463/13

(57) ABSTRACT

A poker game having a second chance feature. A player is allowed to replay a hand of cards in a poker game when the hand of cards includes a triggering hand. The player makes an initial wager and starts the poker game. The player selects which cards to hold and then draws, as in a standard poker game. If the player has a triggering hand in the hand, the player is allowed to discard the results of the draw and replay the hand including a free draw. The present invention can be used in single-hand and multi-hand versions of poker and can be incorporated into a gaming machine.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTION

The present invention relates to a poker game with a second chance feature.

Gaming device manufacturers strive to make gaming devices that provide as much enjoyment and excitement as possible. Video poker machines used for gaming are well known in the art. Most video poker gaming machines used in casinos implement conventional rules for poker by dealing five initial cards face up from a standard deck of fifty-two cards and allowing the player to hold any number of the cards. The player can press a draw button which causes the non-held or discarded cards to be randomly replaced with new cards from the deck. The player is provided an award for a winning hand, if any, according to a payout table.

In a conventional video poker game, when a player is dealt three cards or four cards to a winning hand, such as a Royal Flush, the odds are against the player for filling out the hand and hitting the winning hand. For example, the odds of being dealt a Royal Flush in a five card hand is 1 in 650,000. In a typical single-hand video poker game, the player only gets one chance or draw, resulting in a very high chance of failure and frequent disappointment for the player. In a typical multi-hand game, the player gets one draw for each hand played which reduces the player's overall chance of failure on all hands. However, in the multi-hand games, the player has to place a wager on each hand played, thus the chance of failure relative to the wager for each individual hand is the same as if the player had played only one hand of poker.

In other known embodiments of video poker games, the player has a second opportunity to replay the hand or receive additional draws. One such video poker game is the “Play It Again Poker” game. In this game, the player may replay any hand a second time, but the player has to make an additional wager, thus, like the multi-hand game, the chance of failure has not decreased.

Another video poker game is the “Austin Powers Ten Play Poker #2” game. In this game, the player gets additional draws and no additional wagers are required. However, there is no opportunity for the player to replay a hand that fails.

Games that increase the opportunities and chances to obtain awards are desirable. Players are attracted to games that have increased chances of obtaining sizable awards. Therefore, to increase player enjoyment and excitement, it is desirable to provide new games.

### SUMMARY OF THE INVENTION

The present invention relates in general to a poker game with a second chance feature and in one embodiment primarily described herein, a gaming device having a video poker game with a second chance feature. The gaming device enables a player to play a single-hand poker game or a multi-hand poker game. The gaming device provides the opportunity to replay a hand without the player having to make an additional wager. Thus, the player's chances of obtaining an award per hand relative to the wager placed on the hand is increased which results in a more exciting and entertaining game.

In one embodiment of the present invention, the player makes a wager and is dealt a hand including five initial cards as in a conventional poker game. When a player is dealt a triggering hand such as three cards or four cards to a designated winning hand such as a Royal Flush in an initial deal, the present invention first provides the player with an opportunity for a first draw as in a conventional poker game. The player chooses which initial cards to hold and is dealt replacement cards for the cards not held or chosen by the player. In this embodiment of the present invention, if the player does not obtain the designated winning hand, the player has the option of accepting the hand dealt and any awards associated with that hand after the first draw, or replaying the triggering hand with a free additional draw in a second attempt to obtain the designated winning hand. The player makes no additional wager for such second attempt. If the second attempt results in a winning hand, an award is provided to the player. This embodiment of the present invention provides the player with more chances for awards than a conventional game because the player may be dealt a winning hand in both the initial draw and in the subsequent draw.

It should be appreciated that other pre-determined combinations or triggering hands than three cards to a Royal Flush or four cards to a Royal Flush may be used in accordance with the present invention to provide a player with the opportunity of replaying a hand.

In one embodiment of the present invention, one or more of the cards used in the first draw are replaced back into the deck before for second draw. Thus, such cards may be dealt again to the player in the second draw. In another embodiment, one or more of the cards in the first draw are not placed in the deck. In such embodiment, the player's chance of obtaining the designated winning hand generally increases. Thus, in one embodiment of the present invention, instead of replaying the specific initial hand, the player is allowed to keep the cards held for the first draw, and be dealt additional cards where all of the previous cards which were discarded, including the cards discarded from the initial hand, are randomly shuffled back into the deck. It should be appreciated that in another embodiment of the present invention, the discarded cards may not be shuffled back into the deck of cards.

In one embodiment of the present invention, the player is automatically provided with the free additional draw when there is no designated winning hand after the first draw.

In one embodiment of the present invention, any award that is indicated to the player after the initial draw is not provided to the player if the player chooses to replay the hand. In such case, the player only receives the award, if any, from the replayed hand.

In one embodiment of the present invention, the player is offered the option to replay a hand only if the player has wagered the maximum wager associated with that hand.

In one embodiment of the present invention, the player chooses one or more of the predetermined combinations or triggering hands which gives the player the second chance feature.

It should be appreciated that the present invention could be employed in both single-hand and multi-hand versions of video poker games.

It should be appreciated that the present invention can be played without the use of a gaming device, such as in a conventional table poker game.

It should be appreciated that the present invention could be used in card games other than poker.

It should be appreciated that the present invention could also be used in conjunction with other games such as keno or conventional video slot machines.

It is an advantage of the present invention to provide a gaming device that gives a player the option of replaying a hand with no additional wager or charge.

It is a further advantage of the present invention to provide a gaming device which increases the chances of a player obtaining an award.

Other objects, features and advantages of the invention will be apparent from the following detailed disclosure, taken in conjunction with the accompanying sheets of drawings, wherein like numerals refer to like parts elements, components, steps and processes.

### BRIEF DESCRIPTION OF THE FIGURES

FIG. 1A is a front perspective view of one embodiment of the gaming device of the present invention.

FIG. 1B is a front perspective view of one embodiment of the gaming device of the present invention.

FIG. 2 is a schematic block diagram of the electronic configuration of one embodiment of the gaming device of the present invention.

FIG. 3 is an enlarged front elevation view of one of the display devices of FIGS. 1A and 1B illustrating one embodiment of the present invention wherein the player is dealt an initial hand.

FIG. 4 is an enlarged front elevation view of one of the display devices of FIGS. 1A and 1B illustrating one embodiment of the present invention after the player receives one draw.

FIG. 5 is an enlarged front elevation view of one of the display devices of FIGS. 1A and 1B illustrating one embodiment of the present invention wherein the player is dealt an initial hand.

FIG. 6 is an enlarged front elevation view of one of the display devices of FIGS. 1A and 1B illustrating one embodiment of the present invention after the player receives one draw.

FIG. 7 is an enlarged front elevation view of one of the display devices of FIGS. 1 A and 1B illustrating one embodiment of the present invention after the player receives a free additional draw and has a winning hand which is a Royal Flush.

FIG. 8 is an enlarged front elevation view of one of the display devices of FIGS. 1A and 1B illustrating one embodiment of the present invention enabling the player to choose a triggering hand.

FIG. 9 is an enlarged front elevation view of one of the display devices of FIGS. 1A and 1B illustrating one embodiment of the present invention wherein the player is dealt an initial hand.

FIG. 10 is an enlarged front elevation view of one of the display devices of FIGS. 1A and 1B illustrating one embodiment of the present invention after the player receives one draw.

FIG. 11 is an enlarged front elevation view of one of the display devices of FIGS. 1A and 1B illustrating one embodiment of the present invention after the player receives a free additional draw and has a winning hand which is a Flush.

FIG. 12 is an enlarged front elevation view of one of the display devices of FIGS. 1A and 1B illustrating one embodiment of the present invention wherein the player is dealt an initial hand.

FIG. 13 is an enlarged front elevation view of one of the display devices of FIGS. 1A and 1B illustrating one embodiment of the present invention after the player receives one draw.

FIG. 14 is an enlarged front elevation view of one of the display devices of FIGS. 1A and 1B illustrating one embodiment of the present invention wherein the player is enabled to play a free replay of the triggering hand.

FIG. 15 is an enlarged front elevation view of one of the display devices of FIGS. 1A and 1B illustrating one embodiment of the present invention after the player receives a free additional draw and has a winning hand which is a Four of a Kind.

FIG. 16 is an enlarged front elevation view of one of the display devices of FIGS. 1A and 1B illustrating one embodiment of the present invention wherein the player is dealt an initial hand.

FIG. 17 is an enlarged front elevation view of one of the display devices of FIGS. 1A and 1B illustrating one embodiment of the present invention after the player receives one draw.

FIG. 18 is an enlarged front elevation view of one of the display devices of FIGS. 1A and 1B illustrating one embodiment of the present invention wherein the player is enabled to play a free replay of the triggering hand and any previously dealt card the player chooses.

FIG. 19 is an enlarged front elevation view of one of the display devices of FIGS. 1A and 1B illustrating one embodiment of the present invention after the player receives a free additional draw and has a winning hand which is a Straight.

### DETAILED DESCRIPTION OF THE INVENTION

### Gaming Device and Electronics

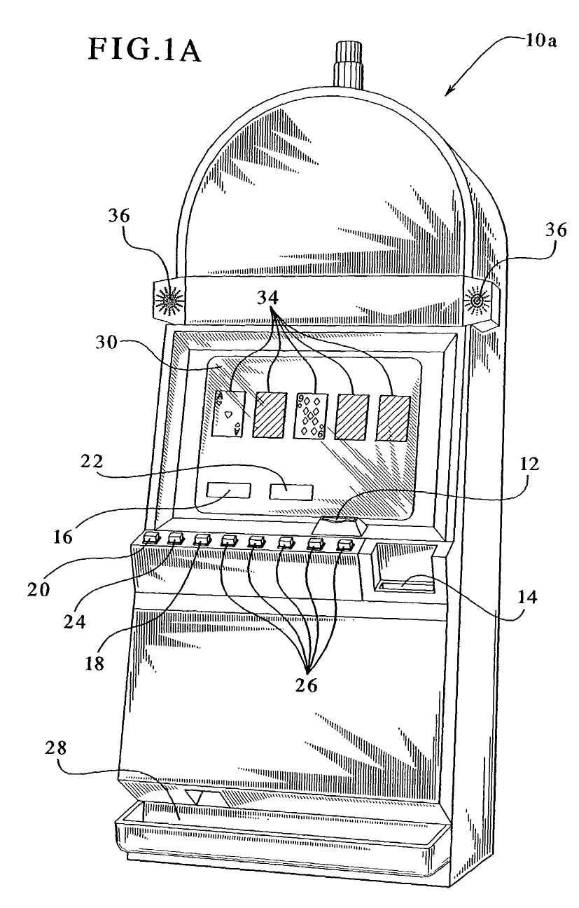

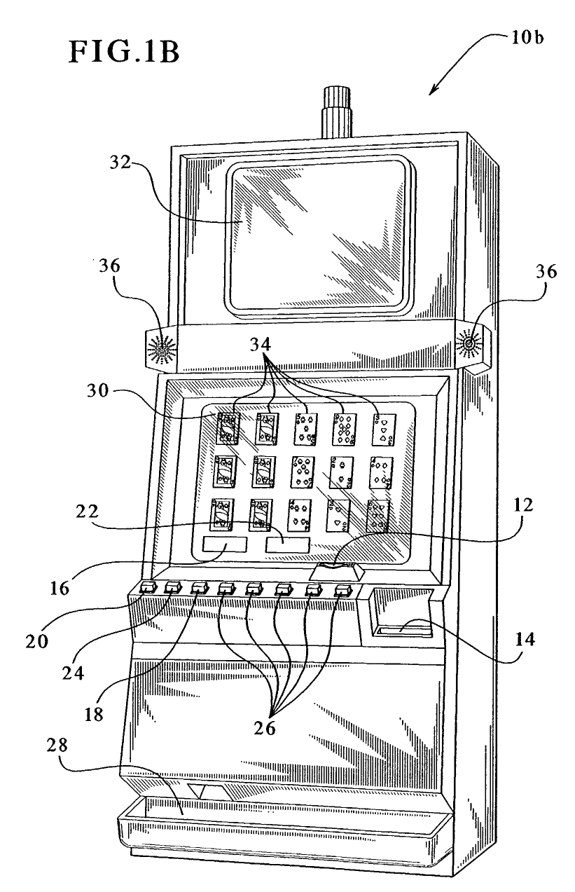

Referring now to the drawings, two embodiments of the gaming device of the present invention are illustrated in FIGS. 1A and 1B as gaming device 10a and gaming device 10b, respectively. Gaming device 10a and/or gaming device 10b are generally referred to herein as gaming device 10. Gaming device 10 in one embodiment has the controls, displays and features of a conventional video poker machine. It is constructed so that a player can operate it while standing or sitting, and gaming device 10 is preferably mounted in a cabinet. However, it should be appreciated that gaming device 10 can be constructed as a pub-style table-top game (not shown) which a player can operate preferably while sitting. Furthermore, gaming device 10 can be constructed with varying cabinet and display designs, as illustrated by the designs shown in FIGS. 1A and 1B. Gaming device 10 can also be implemented as a program code stored in a detachable cartridge for operating a hand-held video game device. Also, gaming device 10 can be implemented as a program code stored on a disk or other memory device which a player can use in a desktop or laptop personal computer or other computerized platform.

As illustrated in FIGS. 1A and 1B, gaming device 10 includes a coin slot 12 and bill acceptor 14 where the player inserts money, coins or tokens. The player can place coins in the coin slot 12 or paper money or ticket vouchers in the bill acceptor 14. Other devices could be used for accepting payment such as readers or validators for credit cards or debit cards. When a player inserts money in gaming device 10, a number of credits corresponding to the amount deposited is shown in a credit display 16. After depositing the appropriate amount of money, a player can begin the game by pushing a play or deal button 20. The play or deal button 20 can be any activator used by the player which starts any game or sequence of events in the gaming device.

As shown in FIGS. 1A and 1B, gaming device 10 also includes a bet display 22 and a bet one button 24. The player places a bet by pushing the bet one button 24. The player can increase the bet by one credit each time the player pushes the bet one button 24. When the player pushes the bet one button 24, the number of credits shown in the credit display 16 decreases by one, and the number of credits shown in the bet display 22 increases by one. Other bet or wager indicators such as a bet max button may also be employed in the gaming device of present invention.

A player may cash out and thereby receive a number of coins corresponding to the number of remaining credits by pushing a cash out button 18. When the player cashes out, the player receives the coins in a coin payout tray 28. The gaming device 10 may employ other payout mechanisms such as credit slips redeemable by a cashier or electronically recordable cards which keep track of the player's credits.

Gaming device 10 also includes one or more display devices. The embodiment shown in FIG. 1A includes a central display device 30, and the alternative embodiment shown in FIG. 1B includes a central display device 30 as well as an upper display device 32. Gaming device 10 in one embodiment displays a plurality of cards 34 in video form at one or more of the display devices. A display device can be any viewing surface such as glass, a video monitor or screen, a liquid crystal display or any other display mechanism. As the cards 34 are in video form, the display device is preferably a video monitor. The cards 34 are associated with one or more decks of cards used in conventional poker games. The cards 34 may alternatively display a variety of images such as bells, hearts, fruits, numbers, letters or other images which may correspond to a theme associated with the gaming device 10. Furthermore, the gaming device 10 preferably includes speakers 36 for producing sounds such as music.

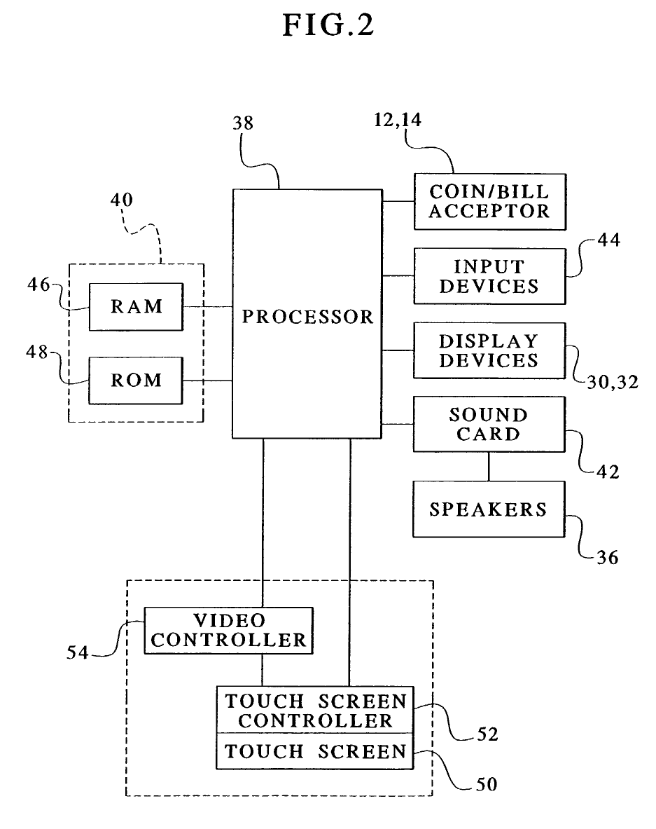

As illustrated in FIG. 2, the general electronic configuration of gaming device 10 preferably includes: a processor 38; a memory device 40 for storing program code or other data; a central display device 30; an upper display device 32; a sound card 42; a plurality of speakers 36; and one or more input devices 44. The processor 38 is preferably a microprocessor or microcontroller-based platform which is capable of displaying images, symbols and other indicia such as images of people, characters, places, things and faces of cards. One or more secondary processors may also be employed in conjunction with the primary processor to control certain aspects of the game function. The memory device 40 can include random access memory (RAM) 46 for storing event data or other data generated or used during a particular game. The memory device 40 can also include read only memory (ROM) 48 for storing program code which controls the gaming device 10 so that it plays a particular game in accordance with applicable game rules and pay tables. The memory device 40 preferably stores program code which enables a player to play a video poker game.

As illustrated in FIG. 2, the player preferably uses the input devices 44, such as the deal button 20, the bet one button 24, the hold buttons 26 and the cash out button 18 to input signals into gaming device 10. In certain instances it is preferable to use a touch screen 50 and an associated touch screen controller 52 instead of a conventional video monitor display device. Touch screen 50 and touch screen controller 52 are connected to a video controller 54 and processor 38. A player can make decisions and input signals into the gaming device 10 by touching touch screen 50 at the appropriate places. As further illustrated in FIG. 2, the processor 38 can be connected to coin slot 12 or bill acceptor 14. The processor 38 can be programmed to require a player to deposit a certain amount of money in order to start the game.

It should be appreciated that although a processor 38 and memory device 40 are preferable implementations of the present invention, the present invention can also be implemented using one or more application-specific integrated circuits (ASIC's) or other hard-wired devices, or using mechanical devices (collectively or alternatively referred to herein as a “processor”). Furthermore, although the processor 38 and memory device 40 preferably reside on each gaming device 10 unit, it is possible to provide some or all of their functions at a central location such as a network server for communication to a playing station such as over a local area network (LAN), wide area network (WAN), Internet connection, microwave link, and the like. The processor 38 and memory device 40 are generally referred to herein as the “computer” or “controller.”

With reference to FIGS. 1A, 1B and 2, to operate the gaming device 10, in one embodiment the player must insert the appropriate amount of money or tokens at coin slot 12 or bill acceptor 14 and then push the deal button 20. The gaming device 10 enables the player to play a conventional game of video poker and initially deals five cards 34 all face up from a single fifty-two card deck. Cards may be “dealt” as in a traditional game of cards or in the case of the gaming device 10, may also include that the cards are randomly selected from a predetermined number of cards. Moreover, the term “shuffling” is also used in the traditional sense and in terms of the gaming device 10, may also include the cards being placed into the predetermined number of cards to be randomly selected or dealt. If the player wishes to draw, the player selects the cards 34 to hold by pressing related hold buttons 26 or the touch screen 50. The player then presses the deal button 20 and the unwanted or discarded cards 34 are removed from the display 30 and replacement cards 34 are dealt from the remaining cards in the deck. This results in a final five-card hand 34. The final five-card hand 34 is compared to a payout table which utilizes conventional poker hand rankings to determine the winning hands. The player is provided with an award based on a winning hand and the credits the player wagered. As long as the player has credits remaining, the player can continue to play additional poker games. It should be appreciated that there may be additional variations of poker games such as a hand having a different number of cards or variations of conventional poker hand rankings which the gaming device 10 can be adapted to play.

In another embodiment, the gaming device 10 enables a player to play a multi-hand version of video poker. In this embodiment, the player is dealt at least two hands of cards 34 as illustrated in FIG. 1B. In one such embodiment, the cards are the same cards. In one embodiment each hand of cards 34 is associated with its own deck of cards. The player chooses the cards 34 to hold in a primary hand. The held cards 34 in the primary hand are also held in the other hands of cards 34. The remaining non-held cards 34 are removed from each hand displayed and for each hand replacement cards are randomly dealt into that hand. Since the replacement cards are randomly dealt independently for each hand, the replacement cards for each hand will usually be different. The poker hand rankings are then determined hand by hand and awards are provided to the player.

In addition to winning credits in this manner, one embodiment gaming device 10 may also gives players the opportunity to win credits in a bonus round. This type of gaming device 10 will include a program which will automatically begin a bonus round when the player has achieved a qualifying condition in the game. This qualifying condition can be a particular arrangement of indicia on a display device. The gaming device 10 may use mechanical devices or a video-based central display device 30 to enable the player to play the bonus round. In one embodiment of the present invention, the qualifying condition for a bonus round may be a predetermined combination of cards appearing on the display, such as a Royal Flush or a Straight. In another embodiment, the predetermined combination of cards may consist of pre-determined combinations from each individual hand or predetermined combinations consisting of cards from a number of hands.

### The Second Chance Feature

In one embodiment of the present invention, if a player receives a predetermined combination or a triggering hand of cards or a triggering event occurs during a poker game, the gaming device allows the player to replay the hand if the player is not satisfied with a subsequent draw.

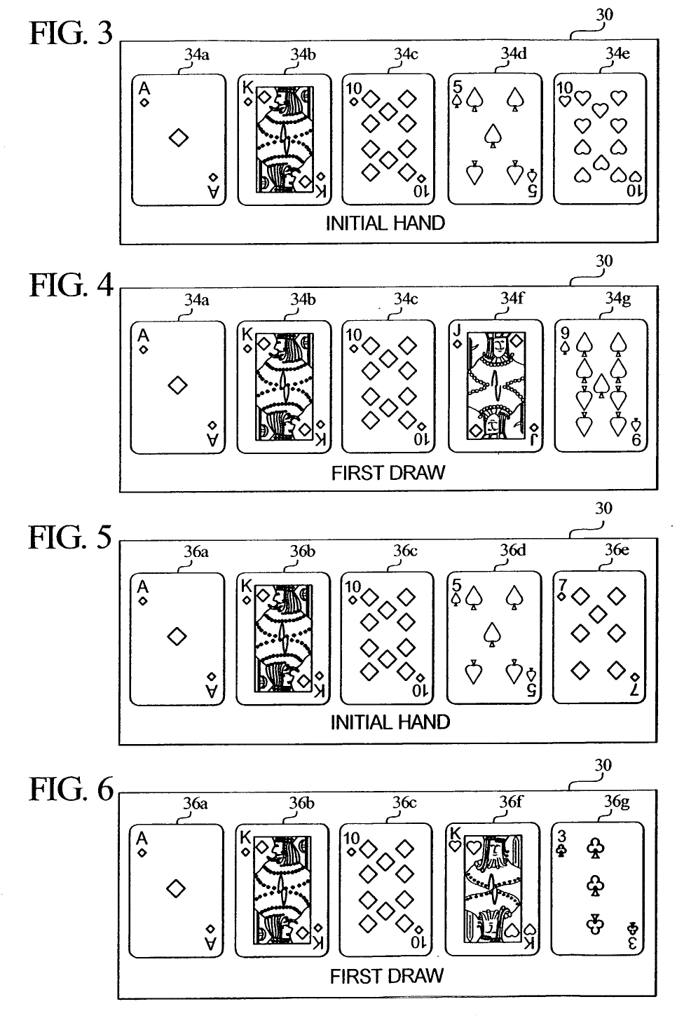

Referring now to FIG. 3, an embodiment of the present invention is illustrated where in a conventional five-card video poker game the player has been dealt an initial hand including an Ace of Diamonds 34a, a King of Diamonds 34b, a Ten of Diamonds 34c, a Five of Spades 34d and a Ten of Hearts 34e. This is not a winning hand, but the hand has three cards to the winning combination which in this embodiment is a Royal Flush. The player holds the Ace of Diamonds 34a, the King of Diamonds 34b, the Ten of Diamonds 34c and requests a draw. The gaming device 10 discards the Five of Spades 34d and the Ten of Hearts 34e, and randomly deals two additional cards including a Jack of Diamonds 34f and a Nine of Spades 34g as illustrated in FIG. 4. The player now holds four cards to a Royal Flush. In a conventional video poker game, the game would end and the player would not be provided with an award because four cards to a Royal Flush is not a winning hand.

In this embodiment of the present invention, the three cards to a Royal Flush is a predetermined combination of cards or triggering hand or event which allows the player to replay the initial hand if the player desires to do so. In such case, in one embodiment, the gaming device 10 shuffles the Jack of Diamonds 34f and the Nine of Spades 34g back into the deck and provides the player with the initial hand as also illustrated in FIG. 3. The gaming device then allows the player to replay the initial hand by allowing the player an additional draw. In one embodiment, any award associated with the first draw is not provided to the player if the player chooses to replay the hand. It should also be appreciated that in one alternative embodiment, the player is allowed to keep the Jack of Diamonds plus the triggering card for the second draw which increases the odds of obtaining the Royal Flush.

Referring now to FIG. 5, in another embodiment of the present invention the player is dealt three cards to a Royal Flush in an initial deal. The player requests a second draw and holds the three cards to a Royal Flush. The Five of Hearts 36d and the Seven of Diamonds 36e are discarded, and two replacement cards are dealt. As illustrated in FIG. 6, the replacement cards are a King of Hearts 36f and a Three of Clubs 36g. In a conventional “Jacks Or Better” poker game the pair of Kings 36b and 36f represents a winning hand and the gaming device 10 provides the player with the award associated with such hand.

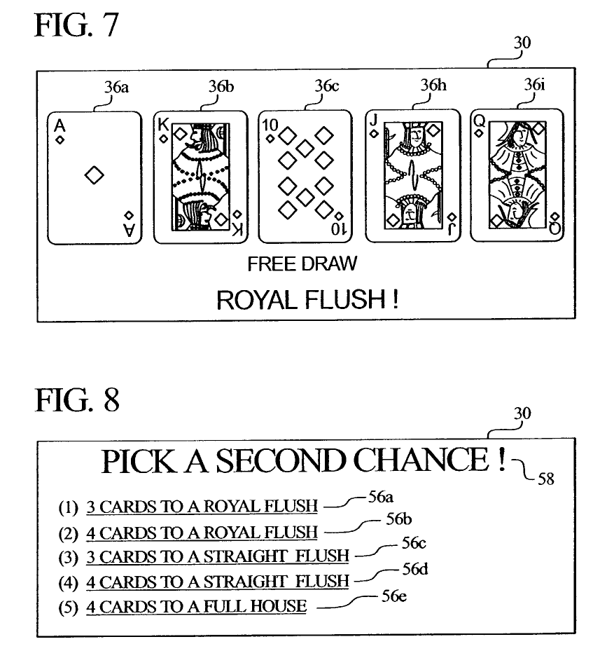

In this embodiment, three cards to a Royal Flush is again a predetermined combination or triggering hand of cards which allows the player to replay the initial hand. The player may elect to replay the hand and give up the award associated with the pair of Kings 36b and 36f or forego replaying the hand and accept the award. The player is thus faced with a decision which is not offered in conventional poker games, that is whether to accept the current award, or to take a chance and try for a larger award. The present invention provides the player with excitement not offered by other poker games. The player takes the chance, replays the initial hand as illustrated in FIG. 5, discards the award and as shown in FIG. 7 and hits a Royal Flush.

It should be appreciated that in one embodiment of the present invention, the award associated with a previous draw given to the player. A player can receive a winning hand in a draw, receive an award, then replay the initial hand and receive another award for a winning hand in the replayed hand, thus, a player has an opportunity to win larger awards not provided in other poker games.

In one embodiment of the present invention illustrated in FIG. 8, the player is given the opportunity to select one or more of the predetermined combinations of cards or triggering hands 56a, 56b, 56c, 56d and 56e which enables a player to play a second chance. The number of selections or selection of a triggering hand by the player can be associated with a wager or maximum wager. This additional selection or selections give a player excitement and decision-making that no other poker game provides.

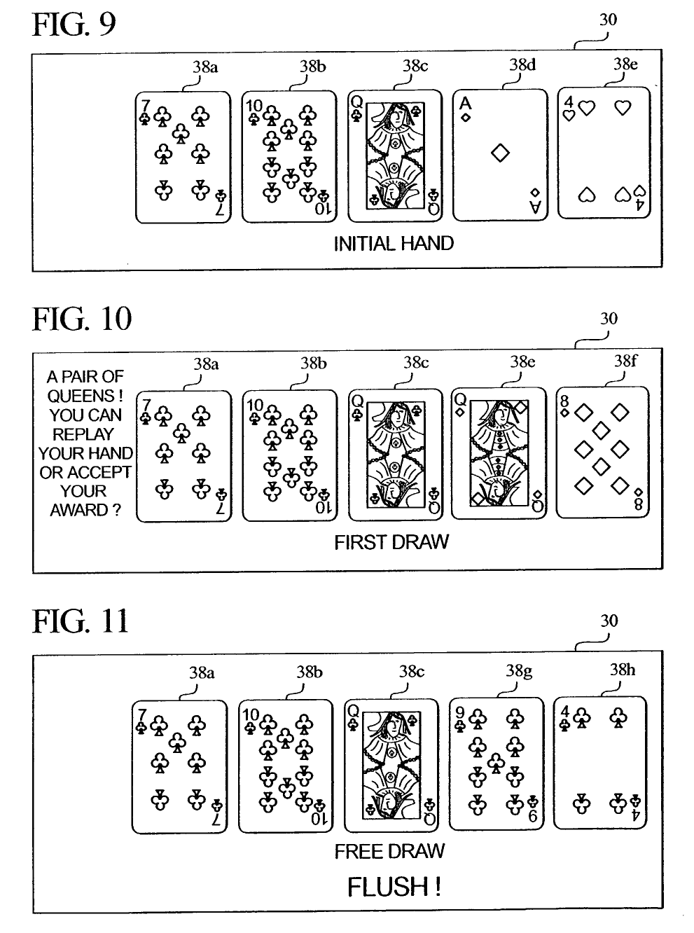

In another embodiment of the present invention, no cards that are previously dealt are shuffled back into the deck, thus, the poker game provides another level of decision-making and excitement. For example, a player is dealt, as illustrated in FIG. 9 three cards to a Flush which includes a Seven of Clubs 38a, a Ten of Clubs 38b, a Queen of Clubs 38c, an Ace of Diamonds 38d, and a Four of Hearts 38e. The player then holds the three cards to the Flush and discards the Ace of Diamonds 38d and the Four of Hearts 38e. The player is then dealt two cards, a Queen of diamonds 38e and an Eight of Diamonds 38f as illustrated in FIG. 10. In a “Jacks Or Better” game the player now holds a winning hand for which an award will be provided. However, in this embodiment of the present invention, the three cards to a Flush is a predetermined combination of cards which allows the player to replay the initial hand. In this embodiment, the cards which were dealt in a previous draw will not be shuffled back into the deck of cards. A player is faced with a decision of whether to accept the award or try for another winning hand which is a Flush. As shown in FIG. 10, the player is informed that he or she can accept the award or replay the hand.

The award associated with a Flush is larger than the award associated with a pair of Queens 38c and 38e. In this embodiment, the player is provided with a better than normal chance of hitting a Flush because two cards in the previous draw and two cards from the initial hand are not in the suit needed for the Flush. These cards will not be in the deck with which the player will replay the hand. In this particular example, the player chooses to replay the initial hand. The player is again provided with the initial hand as illustrated in FIG. 9. The player again holds the three cards to the Flush and discards the Ace of Diamonds 38d and the Four of Hearts 38e. The player is randomly dealt two replacement cards, a Nine of Clubs 38g and a Four of Clubs 38h as illustrated in FIG. 11. In this embodiment, the player hits a Flush which is a winning hand and receives an award.

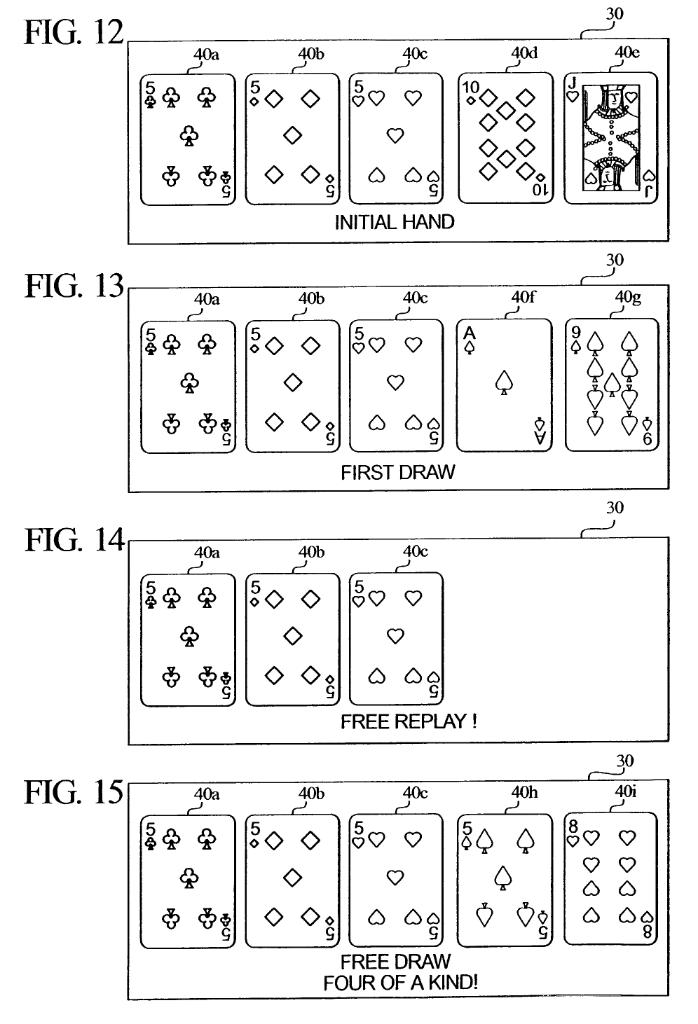

Referring now to FIG. 12, in one embodiment of the present invention, a player is dealt an initial hand of a Five of Clubs 40a, a Five of Diamonds 40b, a Five of Hearts 40c, a Ten of Diamonds 40d, and a Jack of Hearts 40e. The player elects to hold the three Fives 40a, 40b and 40c and discards the Ten of Diamonds 40d and the Jack of Hearts 40e. In the subsequent draw, the player is dealt an Ace of Spades 40f and a Nine of Spades 40g as illustrated in FIG. 13. This is not a designated winning hand, however, the initial hand included three cards to a Four of a Kind, which is a triggering hand in this embodiment. In this embodiment of the present invention, the player may elect to replay the triggering hand for free as illustrated in FIG. 14. The hand which is replayed is only the triggering hand and not the entire hand which included the triggering hand. The player elects to replay the triggering hand and hits Four of a Kind which is a designated winning hand as illustrated in FIG. 15. In this embodiment, all previous cards except the cards in the triggering hand are shuffled back into the deck, however, it should be appreciated that in another embodiment, the discarded cards may not be shuffled back into the deck of cards.

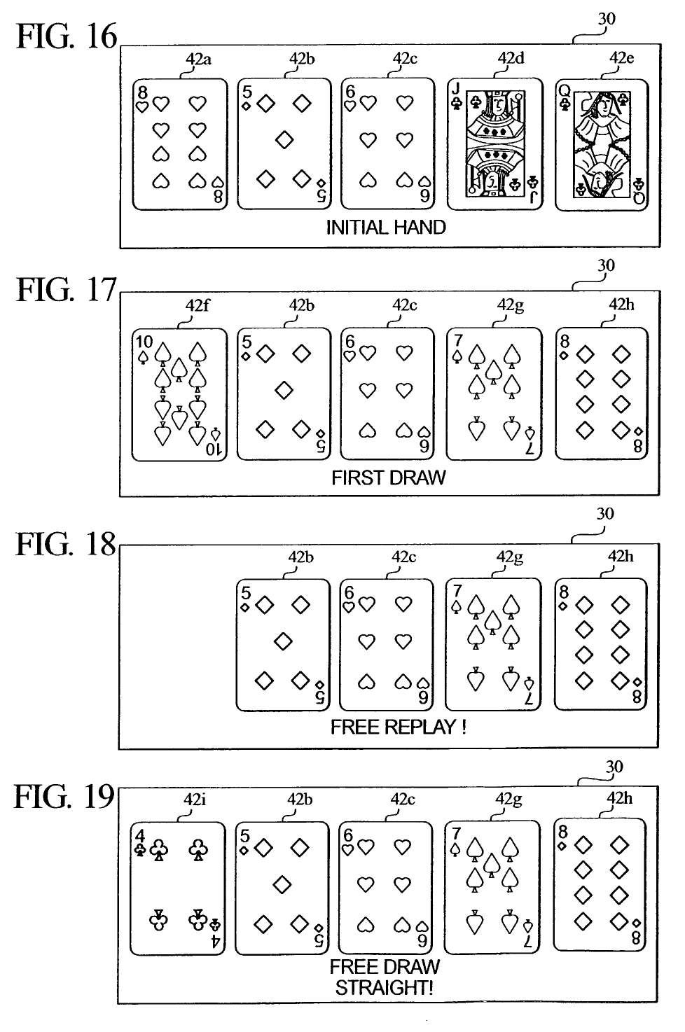

In one embodiment of the present invention, the player is dealt an initial hand of cards as illustrated in FIG. 16. The initial hand includes an Eight of Hearts 42a, a Five of Diamonds 42b, a Six of Hearts 42c, a Jack of Clubs 42d, and a Queen of Clubs 42e. This is not a designated winning hand, so the player elects to hold the Five of Diamonds 42b and the Six of Hearts 42c and discards the remaining cards. In the subsequent draw, the player is dealt a Seven of Spades 42g, an Eight of Diamonds 42h and a Ten of Spades 42f as shown in FIG. 17. This is again not a designated winning hand. In the initial hand the player had two cards to a Straight which is a triggering hand in this embodiment. The player is given the choice to replay the triggering hand for free, however, in this embodiment of the present invention the player may additionally choose to replay with any cards from the first draw as well as the cards in the triggering hand. The initial hand had two cards to a Straight, after the subsequent draw, the hand now also includes a Seven of Spades 42g and an Eight of Diamonds 42h. The hand now includes four cards to a Straight. The chances of hitting a Straight with four cards to a Straight are better than hitting a Straight with two cards to a Straight. The player elects to replay the triggering hand and also holds the Seven of Spades 42g and the Eight of Diamonds 42h for the free replay as illustrated in FIG. 18. The player's choice pays off and after the free draw the player hits a Straight. In this embodiment, all previous cards except the cards in the triggering hand and the cards held after the first draw are shuffled back into the deck. It should be appreciated that in another embodiment, the discarded cards may not be shuffled back into the deck of cards.

In one embodiment of the present invention, the player is automatically provided with the free additional draw when there is no designated winning hand after the first draw.

In one embodiment of the present invention, the predetermined combinations of cards may include: three cards to a Royal Flush, four cards to a Royal Flush, three cards to a Straight Flush, four cards to a Straight Flush, four cards to a Full House, three cards to a Flush, four cards to a Flush, two cards to a Straight, three cards to a Straight, four cards to a Straight, two cards to a Four-of-a-Kind, three cards to a Four-of-a-Kind, two cards to a Three-of-a-Kind, and three cards to a Two Pair. It should be appreciated that the predetermined combination of cards or triggering hand or event is not limited to these combinations, but can be any predetermined combination of cards which will trigger the free replay.

In another embodiment, as described above, the present invention can be modified to be included in a video multi-hand poker game.

Various embodiments of the present invention may also utilize a different number of cards than in conventional poker games.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method of playing a card game, said method comprising the steps of:
(a) dealing at least one hand of cards from at least one card deck to a player upon a wager by the player;
(b) providing the player a first draw from said card deck;
(c) if said hand before or after said first draw includes a triggering hand, enabling the player to replay the cards in the hand which initially included the triggering hand and providing the player a free second draw; and
(d) providing the player an award for any winning hand occurring in said replay.

2. The method of claim 1, wherein all of the cards are dealt face up to the player.

3. The method of claim 1, which includes the step of automatically providing the player with the award associated for any winning hand in the hand after the first draw if the hand does not include the triggering hand.

4. The method of claim 1, wherein if the hand after the first draw includes the winning hand, informing the player of said winning hand and the award associated with said winning hand.

5. The method of claim 4, which includes the step of enabling the player to select between the award associated with the winning hand after the first draw and replaying the cards in said hand which initially included the triggering hand if the hand after said first draw includes the winning hand and the hand before or after said first draw includes the triggering hand.

6. The method of claim 1, which includes the step of automatically causing the player to replay the cards in said hand if said hand after said first draw does not include the winning hand and said hand before or after said first draw includes the triggering hand.

7. The method of claim 1, wherein the replay of the cards is only provided to the player if the player makes at least a predetermined wager in said card game.

8. The method of claim 1, wherein the second draw is from the remaining cards in the card deck which includes the cards previously provided to the player except for the cards in the hand which is being replayed.

9. The method of claim 1, wherein the second draw is from the remaining cards in the card deck excluding the cards previously provided to the player.

10. The method of claim 1, which includes simultaneously playing said card game with a plurality of hands of cards from a plurality of card decks.

11. The method of claim 1, which includes the step of enabling the player to select the triggering hand.

12. The method of claim 11, wherein the number of selections of triggering hands the player can select is based on a wager by the player in said card game.

13. The method of claim 1, wherein the triggering hand is selected from the group consisting of: three cards to a Royal Flush, four cards to a Royal Flush, three cards to a Straight Flush, four cards to a Straight Flush, two pair to a Full House, three cards to a Full House, three cards to a Flush, four cards to a Flush, three cards to a Straight, four cards to a Straight, two cards to a Four-of-a-Kind, three cards to a Four-of-a-Kind, and two cards to a Three-of-a-Kind.

14. The method of claim 1, which includes the step of operating the card game through a data network.

15. The method of claim 14, wherein the data network is an internet.

16. The method of claim 1, wherein computer instructions for implementing steps (a) to (d) are stored in a memory device.

17. A method of playing a card game including a plurality of winning hands, said method comprising of:
(a) dealing a plurality of initial cards from at least one card deck to a player;
(b) enabling the player to select none or at least one of the initial cards to be held;
(c) discarding the initial cards which are not held and replacing each of the discarded cards with a replacement card from the card deck;
(d) if after replacing said discarded cards, the cards include one of the winning hands, displaying to the player an award associated with said winning hand; and
(e) if said initial cards includes a triggering hand, enabling the player to replay the initial cards without an additional wager by the player, wherein the replay includes:
(i) displaying at least the initial cards which were held,
(ii) replacing the cards which were discarded from the initial cards with replacement cards from the card deck, and
(iii) if after replacing the discarded cards, the cards include one of said winning hands, providing an award to the player for said winning hand.

18. The method of claim 17, which includes the step of enabling the player to not replay the cards if the cards after step (d) include one of the winning hands.

19. The method of claim 17, wherein all of the cards are dealt face up to the player.

20. The method of claim 17, which includes the step of providing the player with any award displayed to the player in step (d) if the initial cards did not include the triggering hand.

21. The method of claim 17, which includes the step of enabling the player to select between the award, if any, displayed to the player in step (d) and replaying the initial cards if the cards include one of the winning hands and said initial cards included the triggering hand.

22. The method of claim 17, which includes the step of automatically causing the player to replay the initial cards if after step (c) the cards do not include one of the winning hands and said initial cards included the triggering hand.

23. The method of claim 17, wherein the replay of the initial cards is only provided to the player if the player makes at least a predetermined wager in said card game.

24. The method of claim 17, wherein the replacement cards of step (e)(ii) are selected from the remaining cards in the card deck including the replacement cards of step (c).

25. The method of claim 17, wherein the replacement cards of step (e)(ii) are selected from the remaining cards in the card deck excluding the replacement cards of step (c).

26. The method of claim 17, which simultaneously includes playing said card game with a plurality of hands of cards from a plurality of card decks.

27. The method of claim 17, which includes the step of enabling the player to select the triggering hand.

28. The method of claim 27, wherein the number of selections of triggering hands the player can select is based on a wager by the player in said card game.

29. The method of claim 17, wherein the triggering hand is selected from the group consisting of: three cards to a Royal Flush, four cards to a Royal Flush, three cards to a Straight Flush, four cards to a Straight Flush, two pair to a Full House, three cards to a Full House, three cards to a Flush, four cards to a Flush, three cards to a Straight, four cards to a Straight, two cards to a Four-of-a-Kind, three cards to a Four-of-a-Kind, and two cards to a Three-of-a-Kind.

30. The method of claim 17, which includes the step of operating the card game through a data network.

31. The method of claim 30, wherein the data network is an internet.

32. The method of claim 17, wherein computer instructions for implementing steps (a) to (e) are stored in a memory device.

33. A method of playing a card game including a plurality of winning hands, said method comprising of:
(a) dealing a first hand of cards from a card deck to a player upon a wager by the player;
(b) providing the player a first draw from said card deck;
(c) if said first hand before said first draw includes a triggering hand, enabling the player to play the triggering hand without an additional wager by the player, wherein playing the triggering hand includes:
(i) displaying said triggering hand,
(ii) providing the player a free second draw from the card deck which includes providing at least one card from the card deck to the triggering hand to complete a second hand, and
(iii) if said second hand includes a winning hand, providing an award to the player for said winning hand.

34. The method of claim 33, wherein all of the cards are dealt face up to the player.

35. The method of claim 33, which includes the step of automatically providing the player with an award associated for any winning hand in the first hand after the first draw if the first hand does not include the triggering hand.

36. The method of claim 33, wherein if said first hand after the first draw includes one of the winning hands, displaying to the player an award associated with said winning hand.

37. The method of claim 36, which includes the step of enabling the player to select between the award associated with the winning hand and playing the triggering hand if the first hand after said first draw includes one of the winning hands and said first hand before said first draw includes the triggering hand.

38. The method of claim 33, which includes the step of automatically causing the player to play the triggering hand if said first hand after said first draw does not include one of the winning hands and said first hand before said first draw includes the triggering hand.

39. The method of claim 33, wherein the step of playing the triggering hand is only provided to the player if the player makes at least a predetermined wager in said card game.

40. The method of claim 33, wherein the cards provided to complete the second hand and the second draw are from the card deck which includes all of the cards previously provided to the player to the player which are not included in the triggering hand.

41. The method of claim 33, wherein the cards provided to complete the second hand and the second draw are from the card deck which does not include the cards in the triggering hand and any other cards previously provided to the player.

42. The method of claim 33, which includes simultaneously playing said card game with a plurality of hands of cards dealt from a plurality of card decks.

43. The method of claim 33, which includes enabling the player to select the triggering hand.

44. The method of claim 43, wherein the number of selections of triggering hands the player can select is based on a wager by the player in said card game.

45. The method of claim 33, wherein the triggering hand is selected from the group consisting of: three cards to a Royal Flush, four cards to a Royal Flush, three cards to a Straight Flush, four cards to a Straight Flush, two pair to a Full House, three cards to a Full House, three cards to a Flush, four cards to a Flush, three cards to a Straight, four cards to a Straight, two cards to a Four-of-a-Kind, three cards to a Four-of-a-Kind, and two cards to a Three-of-a-Kind.

46. The method of claim 33, which includes the step of operating the gaming device through a data network.

47. The method of claim 46, wherein the data network is an internet.

48. The method of claim 33, wherein computer instructions for implementing steps (a) to (c) are stored in a memory device.

49. A method of playing a card game including a plurality of winning hands, said method comprising of:
(a) dealing a first hand of cards from a card deck to a player upon a wager by the player;
(b) providing the player a first draw from said card deck to form a second hand;
(c) if said first hand before said first draw includes a triggering hand, enabling the player to obtain a third hand without an additional wager by the player, wherein enabling the player to obtain the third hand includes:
(i) displaying the cards of said triggering hand,
(ii) providing the player a free second draw from said card deck to form the third hand including the triggering hand,
(iii) if the cards in said third hand include one of the winning hands, providing an award to the player for said winning hand.

50. The method of claim 49, wherein all of the cards are dealt face up to the player.

51. The method of claim 49, which includes the step of automatically providing the player with an award associated for any winning hand in said second hand after the first draw if the first hand does not include the triggering hand.

52. The method of claim 49, wherein if said second hand after the first draw includes one of the winning hands, displaying to the player an award associated with said winning hand.

53. The method of claim 52, which includes the step of enabling the player to select between the award associated with said winning hand and obtaining the third hand if the second hand after said first draw includes one of the winning hands and said first hand includes the triggering hand.

54. The method of claim 49, which includes the step of automatically causing the player to obtain the third hand if said second hand after said first draw does not include one of the winning hands and said first hand includes the triggering hand.

55. The method of claim 49, wherein the step obtaining the third hand is only provided to the player if the player makes at least a predetermined wager in said card game.

56. The method of claim 49, which includes simultaneously playing said card game with a plurality of hands of cards dealt from a plurality of card decks.

57. The method of claim 49, which includes enabling the player to select the triggering hand.

58. The method of claim 49, wherein the number of selections of triggering hands the player can select is associated with a wager by the player in said card game.

59. The method of claim 49, wherein the triggering hand is selected from the group consisting of: three cards to a Royal Flush, four cards to a Royal Flush, three cards to a Straight Flush, four cards to a Straight Flush, two pair to a Full House, three cards to a Full House, three cards to a Flush, four cards to a Flush, three cards to a Straight, four cards to a Straight, two cards to a Four-of-a-Kind, three cards to a Four-of-a-Kind, and two cards to a Three-of-a-Kind.

60. The method of claim 49, which includes the step of operating the gaming device through a data network.

61. The method of claim 60, wherein the data network is an internet.

62. The method of claim 49, wherein computer instructions for implementing steps (a) to (c) are stored in a memory device.

63. A gaming device which includes a card game, said gaming device comprising:
a card deck;
at least one hand of cards randomly selected from the card deck;
a first draw from said card deck;
a free second draw from said deck;
at least one award associated with at least one winning hand;
a triggering hand;
at least one display device adapted to display said cards and the award; and
a processor operable with the display device to provide a player with said hand of cards from the card deck, provide the player with the first draw, and upon the hand before or after said first draw including the triggering hand, provide the player with the free second draw, and provide the award to the player if said hand after the free second draw includes the winning hand.

64. The gaming device of claim 63, which includes said processor causing the display device to display the award to the player if after the first draw, said hand includes the winning hand.

65. The gaming device of claim 64, which includes said processor providing the player with the award.

66. The gaming device of claim 63, which includes a plurality of card decks from which the processor enables the player to simultaneously play multiple hands during the card game.

67. The gaming device of claim 63, which includes a plurality of triggering hands, wherein the processor enables the player to select at least one triggering hand.

68. The gaming device of claim 63, wherein said triggering hand is selected from the group consisting of: three cards to a Royal Flush, four cards to a Royal Flush, three cards to a Straight Flush, four cards to a Straight Flush, two pair to a Full House, three cards to a Full House, three cards to a Flush, four cards to a Flush, three cards to a Straight, four cards to a Straight, two cards to a Four-of-a-Kind, three cards to a Four-of-a-Kind, and two cards to a Three-of-a-Kind.

69. A gaming device which includes a card game, said gaming device comprising:
a card deck;
at least one hand of cards randomly selected from the card deck;
a first draw from said card deck;
a free second draw from said card deck;
a award associated with at least one winning hand;
a triggering hand;
at least one display device adapted to display said cards and the award; and
a processor operable with the display device to provide a player with said hand of cards from said card deck, provide the player with the first draw, and upon the hand before or after said first draw including the triggering hand, enabling the player to play the triggering hand, wherein said processor randomly provides cards to the triggering hand from the card deck to complete a new hand, provides the player with the free second draw, and if said new hand after said free second draw includes the winning hand, provide the player with the award.

70. The gaming device of claim 69, which includes said processor causing the display device to display the award to the player if after the first draw, said hand includes the winning hand.

71. The gaming device of claim 70, which includes said processor providing the player with the award.

72. The gaming device of claim 69, which includes a plurality of card decks from which the processor enables the player to simultaneously play multiple hands during the card game.

73. The gaming device of claim 69, which includes a plurality of triggering hands, wherein the processor enables the player to select at least one triggering hand.

74. The gaming device of claim 69, wherein the triggering hand is selected from the group consisting of: three cards to a Royal Flush, four cards to a Royal Flush, three cards to a Straight Flush, four cards to a Straight Flush, two pair to a Full House, three cards to a Full House, three cards to a Flush, four cards to a Flush, three cards to a Straight, four cards to a Straight, two cards to a Four-of-a-Kind, three cards to a Four-of-a-Kind, and two cards to a Three-of-a-Kind.

75. A gaming device which includes a card game, said gaming device comprising:
a card deck;
at least one hand of cards randomly selected from the card deck;
a first draw from said card deck;
a free second draw from said card deck;
a award associated with at least one winning hand;
a triggering hand;
at least one display device adapted to display said cards and the award; and
a processor operable with the display device to provide a player with said hand of cards from the card deck, provide the player with the first draw, and upon the hand before said first draw including the triggering hand, enabling the player to play a new hand, wherein said processor enables the player to select the cards previously provided to the player in said triggering hand to include in said new hand, provides the player the free second draw, and if the new hand after said free second draw includes the winning hand, provides the player with the award.

76. The gaming device of claim 75, which includes said processor causing the display device to display the award to the player if after the first draw, said hand includes the winning hand.

77. The gaming device of claim 76, which includes said processor providing the player with the award.

78. The gaming device of claim 75, which includes a plurality of card decks from which the processor enables the player to simultaneously play multiple hands during the card game.

79. The gaming device of claim 75, which includes a plurality of triggering hands, wherein the processor enables the player to select at least one triggering hand.

80. The gaming device of claim 75, wherein the triggering hand is selected from the group consisting of: three cards to a Royal Flush, four cards to a Royal Flush, three cards to a Straight Flush, four cards to a Straight Flush, two pair to a Full House, three cards to a Full House, three cards to a Flush, four cards to a Flush, three cards to a Straight, four cards to a Straight, two cards to a Four-of-a-Kind, three cards to a Four-of-a-Kind, and two cards to a Three-of-a-Kind.
